(19) United States
(12) Patent Application Publication
(10) Pub. No.: US 2026/0149725 A1
(43) Pub. Date: May 28, 2026

(54) METHOD AND SYSTEM FOR FRAUDULENT CALL DETECTION VIA DUAL-MODEL ANTICIPATION MECHANISM

(71) Applicant: Verizon Patent and Licensing Inc., Basking Ridge, NJ (US)

(72) Inventor: Stanislav Olegovich Miasnikov, Newark, CA (US)

(73) Assignee: Verizon Patent and Licensing Inc., Basking Ridge, NJ (US)

(21) Appl. No.: 18/962,142

(22) Filed: Nov. 27, 2024

(51) Int. Cl. H04L 9/40

(52) U.S. Cl. CPC H04L 63/1425

(57) ABSTRACT

The present teaching relates to detecting a fraudulent call via a dual-model mechanism. Enriched input is generated based on a current block of input tokens from an ongoing communication and the historical context relevant to the current block. Using the enriched input, a normal communication prediction model predicts future tokens to generate a predicted normal communication and a fraudulent communication prediction model predicts future tokens to generate a predicted fraudulent communication. Fraud is detected based on a discrepancy between a sequence of actual input tokens from the ongoing communication and the predicted normal and fraudulent communications.

### BACKGROUND

As communication networks have become increasingly complex and more populated by everyday consumers, fraudulent activities by unsavory actors have also increased. It is a common place nowadays for people to receive unsolicited calls or messages usually associated with unwanted commercial advertisements or sometimes for other purposes such as fraudulent phishing. Such unsolicited communications are often sent to many in bulk and sometimes repeatedly, making them unavoidable and repetitive. This not only causes disturbance to recipients but also wastes valuable resources, including both the network resources and the time of the recipients.

### BRIEF DESCRIPTION OF THE DRAWINGS

The methods, systems and or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 shows an exemplary framework in which a dual-model fraudulent communication detector is provided between a caller and a call receiver to detect fraudulent communications, in accordance with an embodiment of the present teaching;

FIG. 2A depicts an exemplary system diagram of a dual-model fraudulent communication detector, in accordance with an embodiment of the present teaching;

FIG. 2B is a flowchart of an exemplary process of a dual-model fraudulent communication detector, in accordance with an embodiment of the present teaching;

FIG. 3A depicts an exemplary system diagram of an enriched input generator, in accordance with an embodiment of the present teaching;

FIG. 3B is a flowchart of an exemplary process of an enriched input generator, in accordance with an embodiment of the present teaching;

FIG. 4A depicts an exemplary system diagram of a historical context identifier, in accordance with an embodiment of the present teaching;

FIG. 4B shows an exemplary construct of historical content and an example context window for extracting historical context relevant to a block of tokens from an ongoing communication, in accordance with an embodiment of the present teaching;

FIG. 4C is a flowchart of an exemplary process of a historical context identifier, in accordance with an embodiment of the present teaching;

FIG. 5A depicts an exemplary system diagram of a normal communication predictor, in accordance with an embodiment of the present teaching;

FIG. 5B depicts an exemplary system diagram of a fraudulent communication predictor, in accordance with an embodiment of the present teaching;

FIG. 5C is a flowchart of an exemplary process of detecting a future communication, in accordance with an embodiment of the present teaching;

FIG. 5D illustrates a scheme of predicting look-ahead tokens in multiple time steps;

FIG. 6A depicts an exemplary system diagram of a fraud determiner, in accordance with an embodiment of the present teaching;

FIG. 6B is a flowchart of an exemplary process of a fraud determiner, in accordance with an embodiment of the present teaching;

FIG. 7 is an illustrative diagram of an exemplary mobile device architecture that may be used to realize a specialized system implementing the present teaching in accordance with various embodiments; and

FIG. 8 is an illustrative diagram of an exemplary computing device architecture that may be used to realize a specialized system implementing the present teaching in accordance with various embodiments.

### DETAILED DESCRIPTION OF EXAMPLE EMBODIMENTS

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

Fraudulent activities, particularly in telecommunication systems, pose risks to individuals, organizations, and service providers. Traditional fraud detection mechanisms often rely on predefined rules, historical data analysis, or anomaly detection algorithms, which may not be effective against evolving fraud tactics. Real-time fraud detection in conversational settings presents unique challenges due to the dynamic nature of interactions and the need for immediate responses. Recent advances in large language models (LLMs) have shown promise in enhancing the efficiency and accuracy of various natural language processing tasks.

The present teaching discloses a dual-model prediction scheme that leverages the LLMs to detect fraudulent communications in real-time. Two predictive language models are used: a first model trained on fraudulent conversations to anticipate fraudulent content based on input from a current ongoing communication and a second model trained on normal conversations to anticipate typical or normal conversational patterns. By analyzing the divergence between the predicted content from these two models and the actual conversation data using a discrepancy scoring scheme based on a certain similarity metric, the solution as disclosed herein according to the present teaching dynamically identifies deviations from a normal conversation which is indicative of a fraudulent intent. The present teaching may be deployed in a real-time setting, enabling near immediate detection and response to a potential fraud and prompt action to, e.g., terminate a suspicious call or flagging it for review.

Another aspect of the present teaching relates to the ability to dynamically extract relevant historical context from historical content including the ongoing conversation or historical conversations. This context awareness enhances the accuracy of prediction and allows the system to adapt to evolving fraud tactics by recognizing subtle shifts in language and conversational patterns. The fraud detection based on predicted content of normal/fraudulent communications according to the present teaching may further integrate rules developed based on known fraudulent patterns to strengthen its ability to identify and respond to fraud attempts. The combination of dual-model anticipation, dynamic context extraction, and rule-based detection enables a robust and scalable solution for real-time fraud detection in various conversational settings, including telecommunications, customer service interactions, and online platforms.

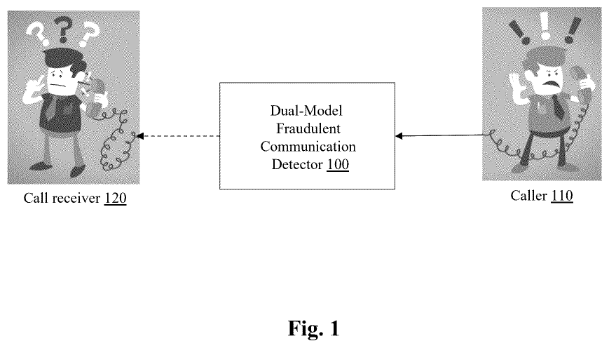

FIG. 1 depicts the fraud detection using a dual-model fraudulent communication detector 100 between a caller 110 and a call receiver 120 to recognize fraudulent communications, according to an embodiment of the present teaching. In this embodiment, the dual-model fraudulent communication detector 100 may be deployed between a caller 110 and a call receiver 120 to detect, based on content of the call, whether the call may be fraudulent. In some situations, the dual-model fraudulent communication detector 100 may be applied on a receiver side. For example, a communication service provider may offer an associated service to its customers to identify, via the dual-model fraudulent communication detector 100, incoming fraudulent calls or messages (e.g., phishing communication) received by its customers. It is also possible to deploy the dual-model fraudulent communication detector 100 at some transmission node of a communication network to, e.g., intercept fraudulent calls/messages.

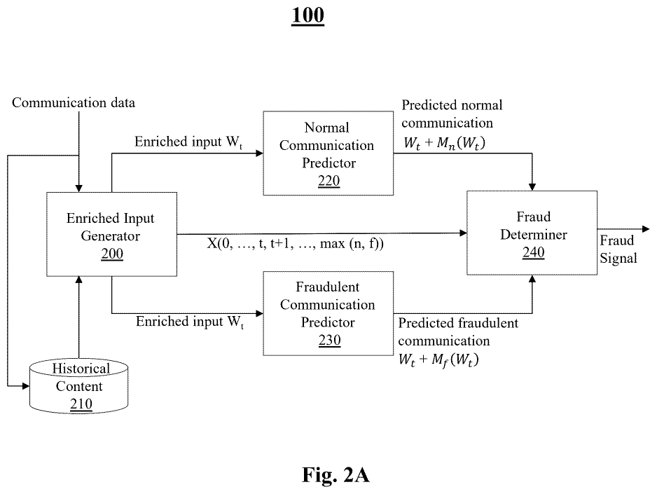

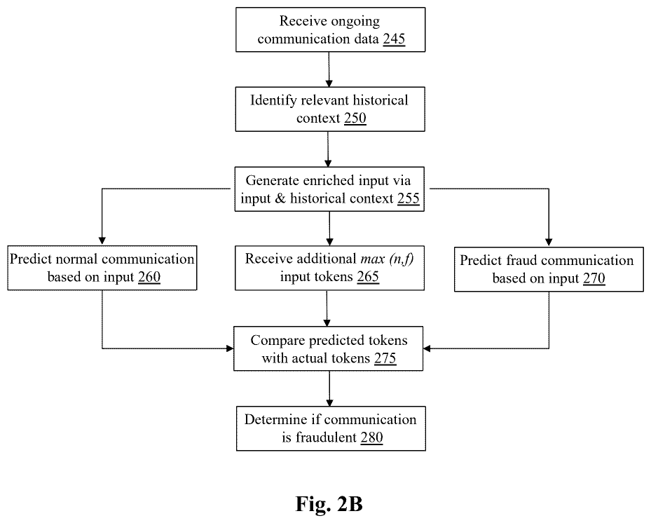

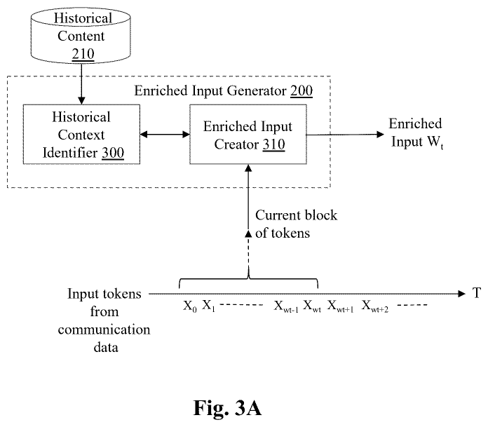

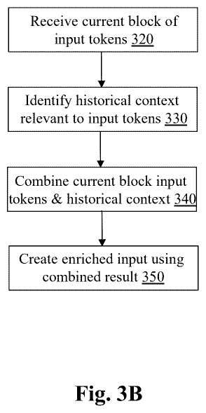

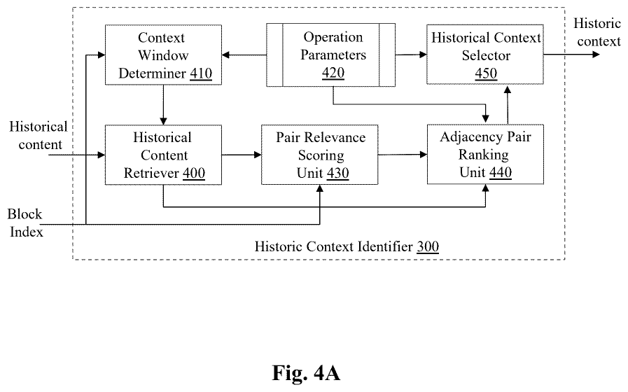

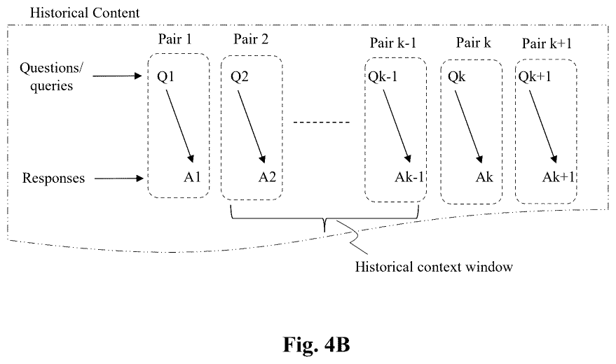

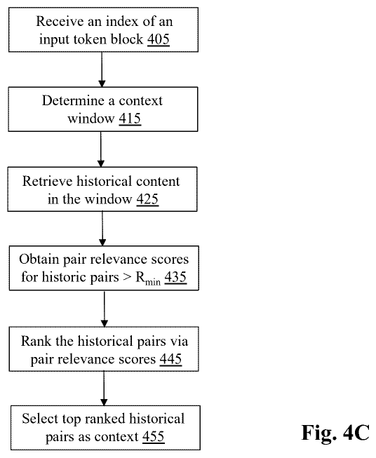

According to the present teaching, the dual-model fraudulent communication detector 100 includes two LLM based prediction models, with one being previously trained to predict a normal conversation and the other being previously trained to predict a fraudulent communication, both based on content from an ongoing communication. Each of the dual models outputs a respective future communication with predicted tokens. Such predicted future token sequences may then be compared with actual tokens from the ongoing communication to determine as to whether the ongoing communication is fraudulent or not. FIG. 2A depicts an exemplary system diagram of the dual-model fraudulent communication detector 100, in accordance with an embodiment of the present teaching. In this illustrated embodiment, the dual-model fraudulent communication detector 100 comprises an enriched input generator 200, a normal communication predictor 220, a fraudulent communication predictor 230, and a fraud determiner 240. The enriched input generator 200 may be provided to create, based on a block of input tokens from an ongoing communication up to moment t, an enriched input denoted by Wₜ, to be provided to the two predictors 220 and 230. In some embodiments, the input data may be enriched using its relevant historical context identified from historical content stored in a storage 210. Details related to the enriched input generator 200 are provided with reference to FIGS. 3A-4C.

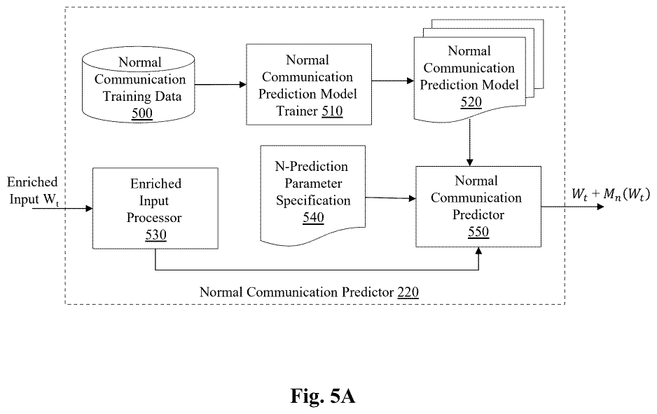

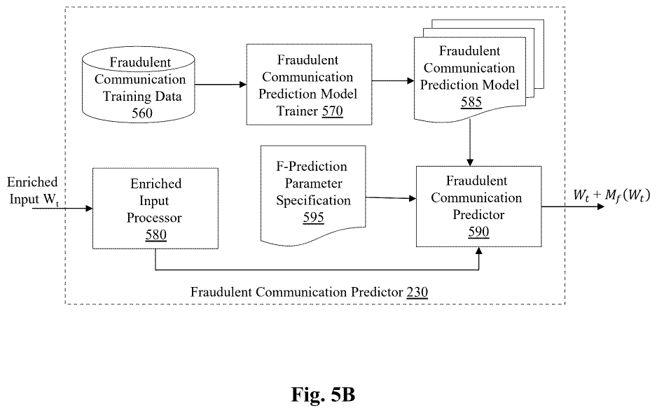

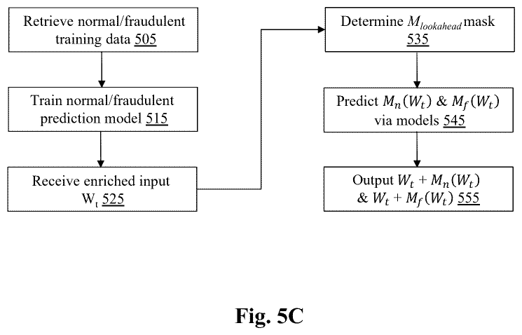

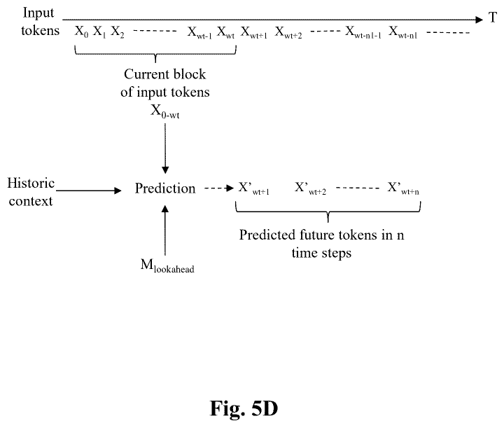

The normal communication predictor 220 is provided to estimate future content of the ongoing communication using a previously trained model for predicting a normal communication. The normal communication predictor 220 predicts n future tokens based on the enriched input Wₜ, (with input token sequence prepended by its historical context). The fraudulent communication predictor 230 is provided to estimate the future content of the ongoing communication using a previously trained model for predicting a fraudulent communication. The fraudulent communication predictor 230 predicts f future tokens based on the enriched input. The predicted normal and fraudulent future communication are both sent to the fraud determiner 240 for fraud detection. Details related to the communication predictors (220 and 230) are provided with reference to FIGS. 5A-5C.

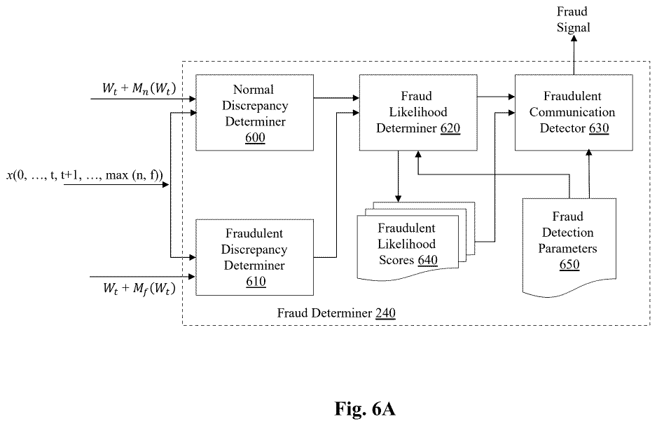

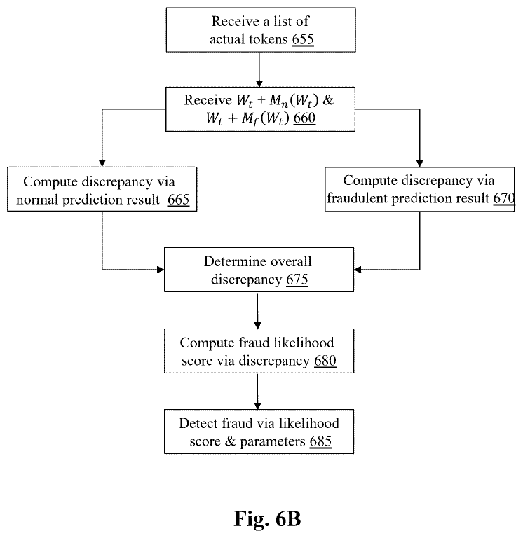

To facilitate fraud detection, the actual input data with tokens up to time t+max (n, f) is received, i.e., x_{(0, . . . , t, t+1, . . . , max(n, f))} or x_{0:max(n,f)}, where, as discussed herein, n is the number of future tokens predicted by the normal communication predictor 220 and f is the number of future tokens predicted by the fraudulent communication predictor 230. This sequence of actual tokens x_{(0, . . . , t, t+1, . . . , max(n, f))}, is also provided to the fraud determiner 240, which determines whether the ongoing communication represents a normal or a fraudulent conversation based on, e.g., the similarities between the actual input tokens and the predicted token sequences from the normal and fraudulent communication predictors 220 and 230, respectively. Details related to the fraud determiner 240 are provided with reference to FIGS. 6A-6B.

FIG. 2B is a flowchart of an exemplary process of the dual-model fraudulent communication detector 100, in accordance with an embodiment of the present teaching. When the enriched input generator 200 receives, at 245, a current block of input tokens up to time t, i.e., x_{(0, . . . , t)}, or x_{0:t} from an ongoing communication, it identifies, at 250, historical context relevant to the input tokens and generates, at 255, an enriched input Wₜ, based on the current block of input tokens in and the relevant historical context. The enriched input Wₜ is provided to both the normal and fraudulent communication predictors 220 and 230. Upon receiving the enriched input Wₜ, the normal communication predictor 220 predicts, at 260 and based on the enriched input, n future tokens based on a normal communication prediction model; while the fraudulent communication predictor 230 predicts, at 265 and based on the enriched input, f future tokens based on a fraudulent communication prediction model. In some situations, n may differ from f. To facilitate fraud detection, the number of predicted future tokens may be k=max (n, f), where one of the prediction results may need to be padded to reach k.

For fraud detection, additional k=max (n, f) actual input tokens may be received at 265 and, together with the previous actual input tokens, an input token sequence up to time t+max (n, f) or x_{0:max(n,f)} (or x_{(0, . . . , t, t+1, . . . , max(n, f))}) may then be provided to the fraud determiner 240. With the n future tokens predicted according to a normal communication, the f future tokens predicted according to a fraudulent communication, and the actual input tokens up to time t+max (n, f), the fraud determiner 240 compares, at 275, the predicted and actual tokens and determines, at 280, if the ongoing communication corresponds to a fraudulent communication.

FIG. 3A depicts an exemplary system diagram of the enriched input generator 200, in accordance with an embodiment of the present teaching. In this illustrated embodiment, the enriched input generator 200 comprises an enriched input creator 310 and a historical context identifier 300. Input is a sequence of actual input tokens, i.e., x₀, x₁, . . . , xₜ, xₜ₊₁, xₜ₊₂, . . . , from the ongoing communication. A current block of input tokens is a subpart of that sequence, e.g., up to time t corresponding to x_{0:t} representing a sub-sequence x₀, x₁, . . . , xₜ. When the enriched input creator 310 receives the current block of input tokens, x_{0:t}, it invokes the historical context identifier 300 to identify, from the historical content archived in storage 210, some of the content therein that is relevant to the received block of tokens. Such identified historical context is then used by the enriched input creator 310, together with the current block of input tokens, to generate the enriched input Wₜ.

FIG. 3B is a flowchart of an exemplary process of the enriched input generator 200, in accordance with an embodiment of the present teaching. When a current block of input tokens of an ongoing communication is received at 320, the historical context identifier 300 is activated to identify, at 330, the historical context relevant to the current block of input tokens. The enriched input creator 310 combines, at 340, the current block of input tokens with the identified historical context to create, at 350, the enriched input to be used for predicting future tokens.

As discussed herein, one aspect of the present teaching relates to extracting relevant historical context on-the-fly from historical content, which may include the transcript of the ongoing conversation or, in some embodiments, transcripts of past communications. This involves selecting textual tokens in a historical context window with respect to historical content based on a relevance scoring scheme. The relevance scores of tokens selected from the historical context window may signify both the importance of such tokens with respect to the underlying content and the contextually relevant content that may be used in predicting the future tokens.

FIG. 4A depicts an exemplary system diagram of the historical context identifier 300, in accordance with an embodiment of the present teaching. In this illustrated embodiment, the historical context identifier 300 comprises a historical content retriever 400, a context window determiner 410, a pair relevance scoring unit 430, an adjacency pair ranking unit 440, and a historical context selector 450. The historical context identifier 300 takes a block of actual input tokens and historical content as input and outputs some contextually relevant content as related to the input tokens. The contextually relevant content is selected from the historical content.

As a dyadic conversation between a potential fraudster and a potential victim progresses, new tokens xₜ up to an input time step t are received. In some embodiments, for each adjacency pair, the first pair part (FPP) attributed to a potential fraudster may be processed, while the second pair part (SPP) attributed to a potential victim of the fraud may be used for the conversation transcript. The tokens in the FPP may be added to a current block of input tokens, denoted by x_{0:t}, where t is the length, in tokens of the FPP at the current time step.

In some embodiments, the historical content may be represented as adjacency pairs from past communications, as illustrated in FIG. 4B. As shown, historical content includes adjacency pairs of prompts and responses extracted from the conversations, e.g., pair 1, pair 2, . . . , pair k−1, pair k, and pair k+1, . . . , and each pair includes a prompt (aka FPP) and a response (aka SPP). Each adjacency pair may be associated with a time stamp so that the pairs temporal order is preserved. A current adjacency pair may sometimes also be referred to as a session. The adjacency pairs from a dyadic conversation may be updated at the end of each session. To extract relevant historical context given a block of input tokens, a historical window may first be defined to limit the scope of pairs to be considered as the historical context. In some embodiments, the window size for the historical context may be determined based on, e.g., the maximum memory capacity of the model and/or the desired context length C. In some embodiments, the window may be determined to always include the adjacency pair of the last session, denoted by T_{t′}. Denoting the historical window by H_{window} for extracting relevant historical context, which is defined as:

$${H}_{window}^{C} = [ {T}_{max ( 0 , {t}^{′} - C )} , … , {T}_{{t}^{′}} ]$$

With the historical window as defined above, the pairs included therein are then used for relevance scoring to measure the relevance between each adjacency pair and the input tokens. The relevance scoring mechanism according to the present teaching may rank tokens included in the pairs in the window based on their importance and relevance to the current input tokens. For example, the importance of a term (token) in a pair may be determined based on its Term Frequency-Inverse Document Frequency (TF-IDF) score computed according to the term's frequency relative to the inverse frequency with respect to the communication. In addition, the relevance between the current input tokens (a block of text) and the historical adjacency pairs (also block of text) may be estimated via their semantic similarity. In some embodiments, such semantic similarity may be determined using cosine similarity between embedding vectors for the current block of text and historical adjacency pairs in the historical window.

The relevance of each adjacency pair Tᵢ in the historical window may be calculated using both importance and similarity of each of part of the adjacency pairs Tᵢ in the historical window, which may be combined to determine a relevant score as follows:

$$Relevance ( {T}_{i} ) = α \cdot TF - IDF ( {T}_{i} ) + ( 1 - α ) \cdot {S}_{C} ( E ( {T}_{i} ) , E ( {x}_{0 : t} ) )$$

where x_{0:t} represents a block of actual input tokens, Tᵢ represents an adjacency pair or a segment of text, and E(Tᵢ) denotes the embedding of that segment, S_{C} denotes cosine similarity function, and α is a hyperparameter determined through, e.g., cross-validation or similar methods and is used to balance components contributions. In some embodiments, the a value may be determined and tuned through cross-validation or grid search on a validation dataset to identify an optimal value that maximize the performance in terms of relevance and coherence of the generated responses according to the specific need of each application.

With such obtained relevance scores for the adjacency pairs in the historical window, the adjacency pairs may be sorted based on their relevance scores while, e.g., preserving the temporal order in relevance groups. In some embodiments, a threshold Rₘᵢₙ may be set to indicate a minimum level of relevance so that any adjacency pair in the historical window that has a relevant score below this threshold may be discarded from further consideration. In some embodiments, an operational parameter K may be specified to represent the number of adjacency pairs to be selected to form the historical context. That is, the historical context Hᵣ for a given block of input tokens is generated by:

$${ℋ}_{r} = Topk ( Relevance ( {H}_{w i n d o w} ) > {R}_{min} )$$

which may then be used to enrich the given block of input tokens to generate more relevant predictions.

It is noted that the block of input tokens may grow over time as the conversation progresses. As such, as historical context window is a sliding window with respect to the input tokens, i.e., it changes over time as well so that the historical context for the changing input token sequence may also adapt accordingly to the input token sequence. In some applications such as in a dyadic conversation, the input token sequence x_{0:t} may be limited to what one party is saying (FPP) and it may be reinitiated each time parties take turns.

As discussed herein, the selected relevant historical tokens (historical context) are used to generate an enrich input for prediction. In some embodiments, the historical relevant pairs may then be prepended to the current input token sequence to form the enriched input Wₜ at time t, which is then used by the normal communication predictor 220 and the fraudulent communication predictor 230 for prediction. That is,

$${W}_{t} = ( {H}_{relevant} , {x}_{0 : t} )$$

As discussed herein, after each prediction until the end of the current FPP, the historical context window with respect to the actual tokens x_{0:t} is updated so that the relevant transcript Hᵣₑₗₑᵥₐₙₜ is adjusted accordingly. Before the end of the each FPP, the current FPP context x_{0:t} may be updated with new actual input tokens as the conversation progresses. The length of the current context may grow with each new input token FPP received. When an FPP is completed, the SPP tokens may be skipped until the next FPP, but the SPP tokens are kept in the transcript for historical context. At the end of each adjacency pair, the historical transcript T may be updated with the tokens from the completed adjacency pair (both FPP and SPP). In this case, the relevant historical window Hᵣₑₗᵥₐₙₜ may then be recalculated based on the updated transcript. After updating the transcript, wₜ may then be reset to zero at the start of each new FPP.

$${T}_{t + k} = [ {x}_{{w}_{t - N}} , {x}_{{w}_{t - N + 1}} , … , {x}_{t} , {x}_{t + 1} , … , {x}_{{w}_{t}} ]$$

where N represents the number of tokens in the last adjacency pair; Tₜ₊ₖ is the updated conversation transcript at time t+k; x_{w}_{_{t−N}} to x_{w}_{ₜ} represent the tokens in the last adjacency pair (before wₜ is reset to 0).

According to the processing disclosed herein, referring back to FIG. 4A, the historical window determiner 410, the historical content retriever 400, the pair relevance scoring unit 430, the adjacency pair ranking unit 440, and historical context selector 450 operate to select the historical context for a given block of input tokens in accordance with the flow as provided in FIG. 4C. When a block of actual input tokens is received, at 405, the context window determiner 410 updates a context window at 415. To determine the historical context window for the block of input tokens, the historical content retriever 400 retrieves, at 425, historical content within the context window. As discussed herein, the retrieved historical content may include adjacency pairs arranged in a sequence according to time stamps thereof. For each of such adjacency pairs, the pair relevance scoring unit 430 obtains, at 435, a relevant score as discussed herein and removes those adjacency pairs that have a relevant score lower than a set minimum threshold Rₘᵢₙ. For the remaining adjacency pairs with relevant scores higher than Rₘᵢₙ, the adjacency pair ranking unit 440 ranks, at 445, them to generate a ranked list of adjacency pairs while preserving the temporal order. The historical context selector 450 then selects, at 455, top K adjacency pairs as the historical context of the given block of input tokens.

FIG. 5A depicts an exemplary system diagram of the normal communication predictor 220, in accordance with an embodiment of the present teaching. The normal communication predictor 220 takes the enriched input Wₜ as input and outputs a predicted normal communication with context, i.e., Wₜ+Mₙ(Wₜ), where Mₙ=Pₙ(t₊₁, . . . , t₊ₙ) represents a sequence of n future tokens predicted according to a normal conservation pattern. In this illustrated embodiment, the normal communication predictor 220 comprises two parts, one for obtaining a normal communication prediction model 520 via machine learning and the other for using the learned normal communication prediction model 520 to predict, based on enriched input Wₜ, n future tokens. The first part includes a normal communication prediction model trainer 510 provided for leveraging normal communication training data 500 for machine learning of a normal communication prediction model 520. It is noted that the training of the normal communication prediction model 520 may be continually carried out when new training data is collected. Such continued learning may not only fine tune the model 520 but also make the model 520 adaptive. The second part includes an enriched input processor 530 and a normal communication predictor 550, where the enriched input processor 530 takes an enriched input Wₜ for processing and the normal communication predictor 550 uses the normal communication prediction model 520 to predict, based on the specified prediction parameter n from 540, Mₙ to generate an overall normal communication context Wₜ+Mₙ(Wₜ) for fraud evaluation.

FIG. 5B depicts an exemplary system diagram of the fraudulent communication predictor 230, in accordance with an embodiment of the present teaching. The fraudulent communication predictor 230 takes the enriched input Wₜ as input and outputs a predicted fraudulent communication with context, i.e., Wₜ+M_{f}(Wₜ), where M_{f}=Pₙ (t₊₁, . . . , t_{+f}) represents a sequence of f future tokens predicted according to a fraudulent conservation pattern. The fraudulent communication predictor 230 is similarly structured with two parts, one for obtaining a fraudulent communication prediction model 580 via model training and the other for using the obtained fraudulent communication prediction model 580 to predict, based on enriched input Wₜ, f future tokens. The first part includes a fraudulent communication prediction model trainer 570 provided for leveraging fraudulent communication training data 560 for machine learning of the fraudulent communication prediction model 580. Similarly, the training of the fraudulent communication prediction model 580 may be continually conducted when new training data is collected. Such continued learning may not only fine tune the model 580 but also make the model 580 adaptive. The second part includes an enriched input processor 585 and a fraudulent communication predictor 590, where the enriched input processor 585 takes an enriched input Wₜ for processing and the fraudulent communication predictor 590 uses the fraudulent communication prediction model 580 to predict, based on the specified prediction parameter f from 595, M_{f} to generate an overall fraudulent communication context Wₜ+M_{f}(Wₜ) for fraud evaluation.

In general, different numbers of future tokens may be predicted for a normal and a fraudulent conversation, using respective prediction models 520 and 580. That is, n and f may not be equal. As discussed herein, to detect fraud, the predicted communication sequences (Mₙ(Wₜ) and M_{f}(Wₜ)) may be compared with an actual token sequence. To do so, max (n, f) may be used to be the number of future tokens in the predicted normal and fraudulent future tokens, where one of them may be padded to meet the required length of max (n, f). With that, the sequence of actual input tokens to be used for fraud detection is x_{0:max(n.f)}, as illustrated in FIG. 2A so that the three sequences (the actual input token sequence, the predicted normal communication sequence Wₜ+Mₙ(Wₜ), and the predicted fraudulent communication sequence Wₜ+M_{f}(Wₜ)) have the same length for comparison. In some situations, it is also possible that actual future tokens of the current FFP maybe shorter than max, which will not impact the determination because the comparison is based on embedding vectors of the actual tokens, as opposed to the actual tokens themselves.

FIG. 5C is a flowchart of an exemplary process of predicting future tokens in response to an enriched input created based on a block of input tokens from an ongoing communication, according to an embodiment of the present teaching. As discussed herein, the prediction of future tokens for a normal and a fraudulent communication operates in a similar way except for the prediction models training and use. As such, their prediction processes presented in FIG. 5C as one, to capture the processing flow of predicting future tokens for either a normal or fraudulent conversation. In operation, to obtain a prediction model (for predicting tokens of either a normal or a fraudulent communication), appropriate training data for fine-tuning the prediction model is received at 505 and used to train or fine-tune the corresponding prediction model at 515. With the fine-tuned model, when an enriched input Wₜ is received at 525, an operational parameter related to the prediction (e.g., M_{lookahead}) is retrieved at 535. The enriched input, at 545, is used to predict future tokens using both models independently. Specifically, the normal communication predictor 220 is predicting Mₙ(Wₜ) using the normal communication prediction model 520 and the fraudulent communication predictor 230 is predicting M_{f}(Wₜ) using the fraudulent communication prediction model 585. The number of predicted tokens is limited by M_{lookahead}. Each prediction result is then integrated with the enriched input Wₜ to generate an overall output at 555. Specifically, in relation to predicting a normal communication, the overall normal communication context produces output as Wₜ+M_{f}(Wₜ), where Mₙ(Wₜ)=Pₙ(t+1, . . . , max(n, f)). In case of predicting a fraudulent communication, the output is the overall fraudulent communication context Wₜ+M_{f}(Wₜ), where M_{f}(Wₜ)=P_{f}(t+1, . . . , max (n, f)).

In some embodiments, the multiple future tokens, predicted by either the normal communication predictor 220 or by the fraudulent communication predictor 230, are predicted at corresponding multiple time steps in a look-ahead manner. FIG. 5D illustrates a scheme of look-ahead prediction of future tokens based on enriched input with input tokens and related historical context, in accordance with an embodiment of the present teaching. As shown, based on a current block of actual input tokens x_{0:w}_{ₜ} and its historical context, the communication predictor (either 220 or 230) operates, based on a look-ahead mask M_{lookahead}, limiting the maximum number of future tokens to be predicted, e.g., n future tokens are predicted in n time steps. The number of predicted future tokens n may or may not equal to k. The n (for normal) and f (for fraudulent) future tokens are predicted one at each time step in an iterative process. In each iteration, the future token predicted in the previous step is also appended to the sequence of input tokens for the prediction at the current iteration. According to the present teaching, both the normal communication predictor 220 and the fraudulent communication predictor 230 are configured to predict future tokens in a look-ahead manner as discussed herein.

As shown in FIG. 2A, the predicted normal communication (from the normal communication predictor 220) and the predicted fraudulent communication (from the fraudulent communication predictor 230) are provided to the fraud determiner 240 for detecting fraud. In addition, the actual input token sequence x_{0:max(n.f)} is also provided to the fraud determiner 240. The actual input sequence is to be compared with the predicted normal and fraudulent token sequences. Discrepancies may be computed and used to detect whether the ongoing communication constitutes a fraudulent communication based on some criterion. FIG. 6A depicts an exemplary system diagram of the fraud determiner 240, in accordance with an embodiment of the present teaching. In this illustrated embodiment, the fraud determiner 240 comprises a normal discrepancy determiner 600, a fraudulent discrepancy determiner 610, a fraud likelihood determiner 620, and a fraudulent communication detector 630. The normal discrepancy determiner 600 is provided to determine a normal discrepancy, denoted by Dₙ, between actual input tokens x_{0:max(n.f)} and the predicted normal future tokens Wₜ+Mₙ(Wₜ). The fraudulent discrepancy determiner 610 is provided for computing the fraudulent discrepancy, denoted by D_{f}, between the actual input tokens and the predicted fraudulent future tokens Wₜ+M_{f}(Wₜ). The fraud likelihood determiner 620 is provided for integrating Dₙ and Dₙ to generate an overall discrepancy metric, denoted by D(t), which is relied on to compute a fraud likelihood score F(t). In some embodiments, the fraud likelihood scores may be computed for different time instances and are stored in a storage 640 to facilitate continuous and cumulative fraud evaluation. Based on the fraud likelihood scores, the fraudulent communication detector 630 is provided to assess the fraud likelihood scores from 640 and decide, according to, e.g., fraud detection parameters specified in 650, whether the ongoing communication corresponds to a fraud.

In some embodiments, the normal/fraudulent discrepancies, i.e., Dₙ and D_{f}, may be determined exclusively based on the new information introduced after t, as the content prior to t is identical and shared, while the discrepancies between the predicted and actual content after t are most likely indicating fraudulent activity. By excluding the shared content (tokens up to time t), the fraudulent discrepancy D_{f} and the normal discrepancy Dₙ may be computed based on comparisons of the immediate future tokens as follows:

$${D}_{f} = {S}_{C} ( E ( {x}_{t + 1 : t + k} ) , E ( {P}_{f} ( t + 1 : t + k ) ) )$$

$${D}_{n} = {S}_{C} ( E ( {x}_{t + 1 : t + k} ) , E ( {P}_{n} ( t + 1 : t + k ) ) )$$

where k=max(n, f), E represents embeddings, and S_{C} represents a similarity metric. As k=max(n, f), padding may be applied as necessary to match the lengths. This approach to determining the discrepancy based only on new tokens after t may be adopted in some situations. For example, in an application where a real-time detection on-the-fly is critically important so that the speed is essential. In this case, only the immediate discrepancies are used for fraud detection to enhance the speed. As another example, in some applications, when a prior context, e.g., before t, is less influential on the meaning of predicted future tokens, this approach may be applied. Thus, this approach may be suitable for scenarios where the primary concern is detecting abrupt changes or anomalies in the conversation.

Alternatively, Dₙ and D_{f} may also be determined based on the entire input and predicted token sequences. That is, the discrepancy computation may consider the entire token sequence up to time t+k, where k=max(n, f), to account for how the input tokens from the ongoing communication as well as the historical context influence the meaning of new predicted future tokens. This alternative approach may capture the continuity and coherence of the conversation, which may be important in situations where the context significantly affects interpretation. In this alternative embodiment, the fraudulent discrepancy D_{f} and the normal discrepancy Dₙ may be computed as follows:

$${D}_{f} = {S}_{C} ( E ( {x}_{0 : t + k} ) , E ( [ {x}_{0 : t} , {P}_{f} ( t + 1 : t + k ) ] ) )$$

$${D}_{n} = {S}_{C} ( E ( {x}_{0 : t + k} ) , E ( [ {x}_{0 : t} , {P}_{n} ( t + 1 : t + k ) ] ) )$$

where again k=max(n, f), E represents embeddings, and S_{C} represents a similarity metric, where padding may be applied as necessary to match the lengths. This alternative approach to determining a discrepancy based only on all tokens and context may be adopted in applications where the meaning of future tokens is highly dependent on previous context. For example, in an application where conversations include complex narratives or where context manipulation is a tactic used by fraudsters. As another example, when an application requires a holistic understanding of the conversation to improve the detection accuracy, this approach may be applied. Thus, this alternative approach to determine discrepancy may be preferable when context plays a significant role in the semantics of the conversation, and subtle discrepancies over time are indicative of fraud. An approach may be chosen to align with the nature of the conversations being analyzed. In some situations, both approached may be implemented to obtain both types of discrepancy metrics and a specific type may be selected based on the effectiveness in operation to achieve a better performance for the specific application.

As discussed herein, the fraudulent discrepancy D_{f} and the normal discrepancy Dₙ may be combined to compute an overall discrepancy D(t). In some embodiments, the overall discrepancy D(t) may be computed as follows:

$$D ( t ) = \frac{1 + ( {D}_{f} ( t ) - {D}_{n} ( t ) )}{2}$$

As the effective range of S_{C} (a similarity metric used in determining D_{f} and Dₙ) may be associated with a range [0,1], defining, e.g., from ‘unrelated’ to ‘very similar’, it follows that the range of both D_{f} and Dₙ is also [0,1]. Hence, D(t)∈[0,1] holds as well. Therefore, this transformation centers the score around 0.5, where values greater than 0.5 indicate a higher likelihood of fraud, while values less than 0.5 suggest a normal conversation. This normalization maps the discrepancy difference to a probability-like range, facilitating easier interpretation and threshold setting.

Based on the overall discrepancy D(t), a fraud likelihood score F(t) may be determined to quantify the confidence that the conversation is fraudulent at each time step. In some embodiments, to prevent issues with unbounded accumulation and ensure that F(t) remains normalized and interpretable, a normalization strategy and bounding mechanism may be introduced. A neutral fraud likelihood score may be initialized for time step 0, e.g., F(0)=0.5. At time step t+1, F(t+1) may be determined by updating F(t) from the previous time step based on the discrepancy score D(t) at that step:

$$F ( t + 1 ) = F ( t ) + δ \cdot ( D ( t ) - 0.5 )$$

where δ∈]0,1] is a scaling factor controlling the sensitivity of the update and D(t)ε[0,1] is centered around 0.5, so (D(t)−0.5) ranges from −0.5 to 0.5. After each update, clip F(t+1) may be normalized to ensure it remains within the valid range:

$$F ( t + 1 ) = min ( max ( F ( t + 1 ) , 0 ) , 1 )$$

By subtracting 0.5 from D(t), we normalize the influence on F(t) such that when D(t)=0.5 (indicating no strong evidence either way), F(t) remains unchanged. Clipping F(t) between 0 and 1 prevents it from exceeding logical bounds, avoiding issues with unbounded accumulation over time. The scaling factor δ allows us to adjust how quickly F(t) responds to new information. A smaller δ makes F(t) change more gradually, providing stability.

To further prevent accumulation issues and ensure that older discrepancies have less influence over time, we introduce a decay factor γ∈[0,1]:

$$F ( t + 1 ) = γ \cdot F ( t ) + δ \cdot ( D ( t ) - 0.5 )$$

The decay factor γ reduces the weight of the previous fraud likelihood score, allowing the system to adapt to new patterns in the conversation. A value of γ close to 1 retains more of the historical influence, while a smaller γ places more emphasis on recent discrepancies. In some embodiments, the operational parameter δ may be determined based on desired sensitivity. For example, δ=0.1 provides moderate responsiveness. On the other hand, parameter γ may be chosen to balance historical context and adaptability. A value like γ=0.9 gives a moderate decay rate.

In the exemplary scheme as discussed herein to compute discrepancies and the fraud likelihood scores, the parameters (e.g., F(0), δ, γ) incorporated in the above formulations may be specified as fraud detection parameters and stored in 650 and they may be updated when needed based on desired performance. In some embodiments, the fraud likelihood score may be provided as a probabilistic output indicating a degree of likelihood that the ongoing communication is fraudulent. The continuous prediction and comparison process involves repeating the prediction and discrepancy analysis steps while updating the fraud likelihood score in real time. In some embodiments, a binary decision may be provided as an output of the fraud determiner 240. In this case, another fraud detection parameter may be specified to provide a threshold on the fraud likelihood score. That is, if the computed fraud likelihood score at some point exceeds the threshold, the ongoing communication is deemed as fraudulent. This threshold can be adjusted based on the desired balance between false positives and false negatives and is inside the range of (0.5, 1.0). When the ongoing communication is considered as fraudulent, some external actions such as terminating the call or marking the call for further review can be triggered.

FIG. 6B is a flowchart of an exemplary process of a fraud determiner 240, in accordance with an embodiment of the present teaching. The sequence of actual input tokens from the ongoing communication is received, at 655, and provided to both the normal discrepancy determiner 600 and the fraudulent discrepancy determiner 610. To compute the normal and fraudulent discrepancies, the normal discrepancy determiner 600 and the fraudulent discrepancy determiner 610 receive, at 660 respectively, the predicted normal token sequence Wₜ+Mₙ(Wₜ) from the normal communication predictor 220 and the predicted fraudulent token sequence Wₜ+M_{f}(Wₜ) from the fraudulent communication predictor 230. Based on the received sequence of actual input tokens and the predicted normal token sequence Wₜ+Mₙ(Wₜ), the normal discrepancy determiner 600 computes, at 665, the discrepancy of the two, i.e., Dₙ. Similarly, based on the received sequence of actual input tokens and the predicted fraudulent token sequence Wₜ+M_{f}(Wₜ), the fraudulent discrepancy determiner 610 computes, at 670, the discrepancy of the two, i.e., D_{f}.

Based on Dₙ and D_{f}, the fraud likelihood determiner 620 accordingly determines, at 675, an overall discrepancy D(t), which is then used to compute, at 680, a fraud likelihood score based on fraud likelihood scores (640) computed for prior time steps and the fraud detection parameters (650). The fraudulent communication detector 630 detects, at 685, whether the ongoing communication is fraudulent based on the fraud likelihood score according to the threshold specified as the detection parameter in 650.

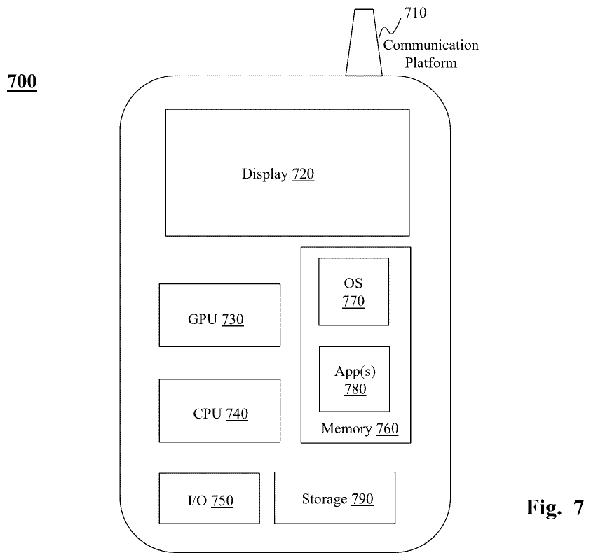

FIG. 7 is an illustrative diagram of an exemplary mobile device architecture that may be used to realize a specialized system implementing the present teaching in accordance with various embodiments. In this example, the user device on which the present teaching may be implemented corresponds to a mobile device 700, including, but not limited to, a smart phone, a tablet, a music player, a handled gaming console, a global positioning system (GPS) receiver, and a wearable computing device, or a mobile computational unit in any other form factor. Mobile device 700 may include one or more central processing units (“CPUs”) 740, one or more graphic processing units (“GPUs”) 730, a display 720, a memory 760, a communication platform 710, such as a wireless communication module, storage 790, and one or more input/output (I/O) devices 750. Any other suitable component, including but not limited to a system bus or a controller (not shown), may also be included in the mobile device 700. As shown in FIG. 7, a mobile operating system 770 (e.g., iOS, Android, Windows Phone, etc.) and one or more applications 780 may be loaded into memory 760 from storage 790 to be executed by the CPU 740 or GPUs 730. The applications 780 may include a user interface or any other suitable mobile apps for information exchange, analytics, and management according to the present teaching on, at least partially, the mobile device 700. User interactions, if any, may be achieved via the I/O devices 750 and provided to the various components thereto.

To implement various modules, units, and their functionalities as described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

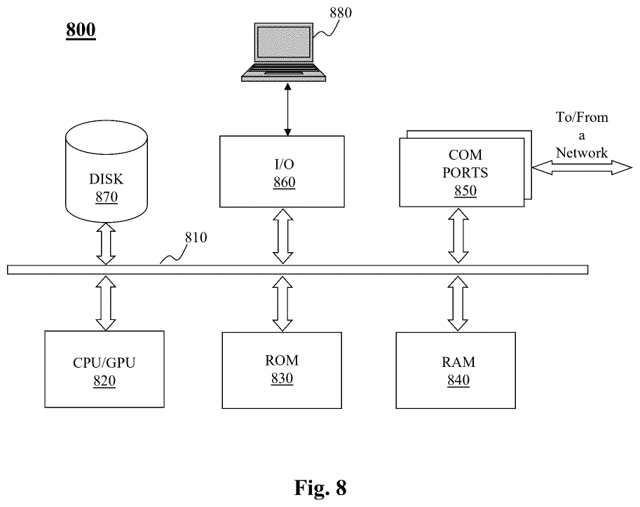

FIG. 8 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 800 may be used to implement any component or aspect of the framework as disclosed herein. For example, the information processing and analytical method and system as disclosed herein may be implemented on a computer such as computer 800, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 800, for example, includes COM ports 850 connected to and from a network connected thereto to facilitate data communications. Computer 800 also includes one or more central processing unit (CPU) and/or one or more graphic processing units (“GPUs”) 820, in the form of one or more processors, for executing program instructions. The exemplary computer platform includes an internal communication bus 810, program storage and data storage of different forms (e.g., disk 870, read only memory (ROM) 830, or random-access memory (RAM) 840), for various data files to be processed and/or communicated by computer 800, as well as possibly program instructions to be executed by the one or more CPU/GPUs 820. Computer 800 also includes an I/O component 860, supporting input/output flows between the computer and other components therein such as user interface elements 880. Computer 800 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

It is noted that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

In the preceding specification, various example embodiments have been described with reference to the accompanying drawings. It will, however, be evident that various modifications and changes may be made thereto, and additional embodiments may be implemented, without departing from the broader scope of the present teaching as set forth in the claims that follow. The specification and drawings are accordingly to be regarded in an illustrative rather than restrictive sense.

We claim:

1. A method, comprising:
receiving a current block of input tokens from an ongoing communication;
identifying, from historical content, historical context relevant to the current block of input tokens;
generating enriched input for predicting future tokens based on the current block of input tokens and the historical context;
predicting, by a normal communication prediction model based on the enriched input, a first set of future tokens to generate a predicted normal communication;
predicting, by a fraudulent communication prediction model based on the enriched input, a second set of future tokens to generate a predicted fraudulent communication;
receiving additional input tokens from the ongoing communication to generating a sequence of actual input tokens;
determining an overall discrepancy between the sequence of actual input tokens and the predicted normal and fraudulent communications; and
determining whether the ongoing communication corresponds to a fraudulent communication.

2. The method of claim 1, wherein the identifying historical context comprises:
determining a context window associated with the historical context based on the current block;
retrieving historical content within the context window, wherein the retrieved historical content corresponds to previous communications represented by a plurality of prompt/response adjacency pairs;
obtaining a relevance score between each of the plurality of adjacency pairs and the current block of input tokens;
ranking the plurality of adjacency pairs based on their respective relevance scores;
selecting a predetermined number of top ranked adjacency pairs; and
creating the historical context for the current block of input tokens based on the selected top ranked adjacency pairs.

3. The method of claim 2, wherein the obtaining a relevance score comprises:
determining a first metric representing importance of terms in the adjacency pair;
determining a second metric representing semantic similarity between the adjacency pair and the current block of input tokens;
retrieving an operational parameter for combining the first and the second metric; and
determining the relevance score for the adjacency pair based on the first metric and the second metric in accordance with the operational parameter.

4. The method of claim 1, wherein:
predicting the first set of future tokens comprises:
predicting, using the normal communication prediction model, a look-ahead normal future token based on the enriched input,
adding the predicted look-ahead normal future token to the enriched input,
repeating the predicting a look-ahead normal future token and adding the predicted look-ahead normal future token until the first set of future tokens are predicted, and
creating the predicted normal communication based on the first set of future tokens; and
predicting the second set of future tokens comprises:
predicting, using the fraudulent communication prediction model, a look-ahead fraudulent future token based on the enriched input,
adding the predicted look-ahead fraudulent future token to the enriched input,
repeating the predicting a look-ahead fraudulent future token and adding the predicted look-ahead fraudulent future token until the second set of future tokens are predicted, and
creating the predicted fraudulent communication based on the second set of future tokens.

5. The method of claim 1, wherein the determining an overall discrepancy comprises:
computing
a first discrepancy between the sequence of actual input tokens and the predicted normal communication, and
a second discrepancy between the sequence of actual input tokens and the predicted fraudulent communication; and
determining the overall discrepancy based on the first discrepancy and the second discrepancy.

6. The method of claim 1, wherein the determining whether the ongoing communication corresponds to a fraudulent communication comprises:
obtaining a fraud likelihood metric based on the overall discrepancy, wherein the fraud likelihood metric representing confidence that the ongoing communication is fraudulent; and
generating a fraud signal based on the fraud likelihood metric indicating a fraud detection result.

7. The method of claim 6, further comprising determining, based on the fraud signal, an action directed to the ongoing communication, wherein the action includes at least one of:
terminating the ongoing communication; and
flagging the ongoing communication for a review.

8. A machine-readable and non-transitory medium having information recorded thereon, wherein the information, when read by the machine, causes the machine to perform the following steps:
receiving a current block of input tokens from an ongoing communication;
identifying, from historical content, historical context relevant to the current block of input tokens;
generating enriched input for predicting future tokens based on the current block of input tokens and the historical context;
predicting, by a normal communication prediction model based on the enriched input, a first set of future tokens to generate a predicted normal communication;
predicting, by a fraudulent communication prediction model based on the enriched input, a second set of future tokens to generate a predicted fraudulent communication;
receiving additional input tokens from the ongoing communication to generating a sequence of actual input tokens;
determining an overall discrepancy between the sequence of actual input tokens and the predicted normal and fraudulent communications; and
determining whether the ongoing communication corresponds to a fraudulent communication.

9. The medium of claim 8, wherein the identifying historical context comprises:
determining a context window associated with the historical context based on the current block;
retrieving historical content within the context window, wherein the retrieved historical content corresponds to previous communications represented by a plurality of prompt/response adjacency pairs;
obtaining a relevance score between each of the plurality of adjacency pairs and the current block of input tokens;
ranking the plurality of adjacency pairs based on their respective relevance scores;
selecting a predetermined number of top ranked adjacency pairs; and
creating the historical context for the current block of input tokens based on the selected top ranked adjacency pairs.

10. The medium of claim 9, wherein the obtaining a relevance score comprises:
determining a first metric representing importance of terms in the adjacency pair;
determining a second metric representing semantic similarity between the adjacency pair and the current block of input tokens;
retrieving an operational parameter for combining the first and the second metric; and
determining the relevance score for the adjacency pair based on the first metric and the second metric in accordance with the operational parameter.

11. The medium of claim 8, wherein:
predicting the first set of future tokens comprises:
predicting, using the normal communication prediction model, a look-ahead normal future token based on the enriched input,
adding the predicted look-ahead normal future token to the enriched input,
repeating the predicting a look-ahead normal future token and adding the predicted look-ahead normal future token until the first set of future tokens are predicted, and
creating the predicted normal communication based on the first set of future tokens; and
predicting the second set of future tokens comprises:
predicting, using the fraudulent communication prediction model, a look-ahead fraudulent future token based on the enriched input,
adding the predicted look-ahead fraudulent future token to the enriched input,
repeating the predicting a look-ahead fraudulent future token and adding the predicted look-ahead fraudulent future token until the second set of future tokens are predicted, and
creating the predicted fraudulent communication based on the second set of future tokens.

12. The medium of claim 8, wherein the determining an overall discrepancy comprises:
computing
a first discrepancy between the sequence of actual input tokens and the predicted normal communication, and
a second discrepancy between the sequence of actual input tokens and the predicted fraudulent communication; and
determining the overall discrepancy based on the first discrepancy and the second discrepancy.

13. The medium of claim 8, wherein the determining whether the ongoing communication corresponds to a fraudulent communication comprises:
obtaining a fraud likelihood metric based on the overall discrepancy, wherein the fraud likelihood metric representing confidence that the ongoing communication is fraudulent; and
generating a fraud signal based on the fraud likelihood metric indicating a fraud detection result.

14. The medium of claim 13, wherein the information, when read by the machine, further causes the machine to perform determining, based on the fraud signal, an action directed to the ongoing communication, wherein the action includes at least one of:
terminating the ongoing communication; and
flagging the ongoing communication for a review.

15. A system, comprising:
an enriched input generator implemented by a processor and configured for
receiving a current block of input tokens from an ongoing communication,
identifying, from historical content, historical context relevant to the current block of input tokens, and
generating enriched input for predicting future tokens based on the current block of input tokens and the historical context;
a normal communication predictor implemented by a processor and configured for predicting, based on a normal communication prediction model according to the enriched input, a first set of future tokens to generate a predicted normal communication;
a fraudulent communication predictor implemented by a processor and configured for predicting, based on a fraudulent communication prediction model according to the enriched input, a second set of future tokens to generate a predicted fraudulent communication;
a fraud determiner implemented by a processor and configured for
receiving additional input tokens from the ongoing communication to generating a sequence of actual input tokens,
determining an overall discrepancy between the sequence of actual input tokens and the predicted normal and fraudulent communications, and
determining whether the ongoing communication corresponds to a fraudulent communication.

16. The system of claim 15, wherein the identifying historical context comprises:
determining a context window associated with the historical context based on the current block;
retrieving historical content within the context window, wherein the retrieved historical content corresponds to previous communications represented by a plurality of prompt/response adjacency pairs;
obtaining a relevance score between each of the plurality of adjacency pairs and the current block of input tokens;
ranking the plurality of adjacency pairs based on their respective relevance scores;
selecting a predetermined number of top ranked adjacency pairs; and
creating the historical context for the current block of input tokens based on the selected top ranked adjacency pairs.

17. The system of claim 16, wherein the obtaining a relevance score comprises:
determining a first metric representing importance of terms in the adjacency pair;
determining a second metric representing semantic similarity between the adjacency pair and the current block of input tokens;
retrieving an operational parameter for combining the first and the second metric; and
determining the relevance score for the adjacency pair based on the first metric and the second metric in accordance with the operational parameter.

18. The system of claim 15, wherein:
predicting the first set of future tokens comprises:
predicting, using the normal communication prediction model, a look-ahead normal future token based on the enriched input,
adding the predicted look-ahead normal future token to the enriched input,
repeating the predicting a look-ahead normal future token and adding the predicted look-ahead normal future token until the first set of future tokens are predicted, and
creating the predicted normal communication based on the first set of future tokens; and
predicting the second set of future tokens comprises:
predicting, using the fraudulent communication prediction model, a look-ahead fraudulent future token based on the enriched input,
adding the predicted look-ahead fraudulent future token to the enriched input,
repeating the predicting a look-ahead fraudulent future token and adding the predicted look-ahead fraudulent future token until the second set of future tokens are predicted, and
creating the predicted fraudulent communication based on the second set of future tokens.

19. The system of claim 15, wherein the determining an overall discrepancy comprises:
computing
a first discrepancy between the sequence of actual input tokens and the predicted normal communication, and
a second discrepancy between the sequence of actual input tokens and the predicted fraudulent communication; and
determining the overall discrepancy based on the first discrepancy and the second discrepancy.

20. The system of claim 15, wherein the determining whether the ongoing communication corresponds to a fraudulent communication comprises:
obtaining a fraud likelihood metric based on the overall discrepancy, wherein the fraud likelihood metric representing confidence that the ongoing communication is fraudulent;
generating a fraud signal based on the fraud likelihood metric indicating a fraud detection result; and
if the fraud signal is generated, determining an action directed to the ongoing communication, wherein the action includes at least one of:
terminating the ongoing communication, and
flagging the ongoing communication for a review.
